(19) United States
(12) Patent Application Publication
(10) Pub. No.: US 2026/0039936 A1
(43) Pub. Date: Feb. 5, 2026

(54) IMAGING DEVICE, IN-VEHICLE CAMERA, AND TRANSPORTATION APPARATUS

(71) Applicant: CANON KABUSHIKI KAISHA, Tokyo (JP)

(72) Inventor: TATSUYA TANAKA, Tokyo (JP)

(21) Appl. No.: 19/276,609

(22) Filed: Jul. 22, 2025

(30) Foreign Application Priority Data
Aug. 1, 2024 (JP) 2024-125744

(51) Int. Cl. H04N 23/52; B60R 11/00; G02B 7/02; H04N 23/51

(52) U.S. Cl. CPC H04N 23/52; B60R 11/00; G02B 7/028; H04N 23/51; B60R 2011/0003

(57) ABSTRACT

An imaging device includes a lens, a lens holding member for holding the lens, the lens holding member having a first thermal conductivity, an imaging unit including an image sensor and an image sensor holder, and an enclosure accommodating the lens holding member and the imaging unit, wherein the imaging unit is configured such that a position of the image sensor shifts toward the lens as a temperature of the image sensor holder increases, wherein the imaging device further comprises a thermal conductive member that has a second thermal conductivity and is accommodated within the enclosure, the thermal conductive member being different from the enclosure a part of which is connected to the image sensor holder and another part of which is connected to the lens holding member, and wherein the second thermal conductivity is equal to or greater than the first thermal conductivity.

### BACKGROUND

### Field of the Technology

The present disclosure relates to an imaging device, an in-vehicle camera, and a transportation apparatus.

### Description of the Related Art

Some recent vehicles have been equipped with in-vehicle cameras, such as sensing cameras for driver assistance and/or autonomous driving, as well as cameras for capturing the surroundings of the vehicles. The images captured by the in-vehicle cameras are used to detect white lane markings, obstacles, and other objects through desired image processing, and are utilized for controlling the vehicle.

In terms of cost and device miniaturization, many in-vehicle cameras are configured with a fixed-focus design, without the autofocus function commonly used in general digital still cameras and the like. Furthermore, in-vehicle cameras are demanded to operate stably and maintain high performance under a wide range of ambient temperatures and various solar radiation conditions.

Changes in ambient temperature lead to shifts in back focus (the distance from the end of the lens closest to the image sensor to the focal point). When the ambient temperature rises, the back focus of the optical system usually decreases due to an increase in a lens interval, a change in the temperature characteristics of the refractive index of the lens glass material, and other factors. In addition, since the in-vehicle camera is often disposed to face the windshield of the vehicle, the temperature of the lens and/or the lens barrel may rise due to solar radiation. The temperature rise of the lens and/or the lens barrel due to the solar radiation also leads to the shortening of the back focus of the optical system.

In order for a fixed-focus in-vehicle camera to maintain high performance over a wide range of ambient temperatures and various solar conditions, the image sensor is required to remain within the depth of focus of the optical system to accommodate shifts in back focus caused by changes in ambient temperature and solar radiation.

Japanese Patent Laid-Open No. 2024-2151 describes a configuration in which an image sensor substrate is held by an image sensor plate, and the image sensor substrate is curved convexly toward the lens side in response to ambient temperature changes. This curvature can reduce or prevent the increase in flange back distance (the distance from a lens barrel mounting surface to an image plane) caused by temperature changes. Japanese Unexamined Patent Application Publication No. 2019-530887 describes a technique in which a back plate supporting an image sensor includes a two-material element designed to be curved in response to ambient temperature changes, thereby allowing the image sensor to accommodate thermal displacement in back focus.

The conventional techniques described in the above patent documents enable response to back focus shifts caused by changes in ambient temperature, in cases where the temperature of the entire imaging device uniformly rises or falls. However, in all of these conventional techniques, the position of the image sensor along the optical axis direction depends on ambient temperature, making it difficult to respond to back focus shifts caused by partial heating or cooling of the in-vehicle camera due to solar radiation, which has a significant effect particularly in in-vehicle cameras.

### SUMMARY

Thus, the present disclosure is directed to providing an imaging device capable of maintaining excellent imaging performance even when back focus shift occurs due to changes in ambient temperature and the effects of solar radiation, as well as an in-vehicle camera and a transportation apparatus including the imaging device.

According to some embodiments of the present disclosure, an imaging device includes a lens, a lens holding member for holding the lens, the lens holding member having a first thermal conductivity, an imaging unit including an image sensor and an image sensor holder, and an enclosure accommodating the lens holding member and the imaging unit, wherein the imaging unit is configured such that a position of the image sensor shifts toward the lens as a temperature of the image sensor holder increases, wherein the imaging device further comprises a thermal conductive member that has a second thermal conductivity and is accommodated within the enclosure, the thermal conductive member being different from the enclosure a part of which is connected to the image sensor holder and another part of which is connected to the lens holding member, and wherein the second thermal conductivity is equal to or greater than the first thermal conductivity.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an in-vehicle camera according to an embodiment of the present disclosure.

FIG. 2 is a cross-sectional view of a lens barrel unit according to an embodiment of the present disclosure.

FIGS. 3A and 3B are diagrams illustrating an image sensor and an image sensor substrate according to an embodiment of the present disclosure.

FIGS. 4A to 4C are diagrams illustrating a configuration of an image sensor holder according to an embodiment of the present disclosure.

FIGS. 5A and 5B are diagrams illustrating a method of fixing the image sensor to the image sensor holder according to an embodiment of the present disclosure.

FIGS. 6A to 6C are diagrams illustrating a method of fixing a lens barrel unit and an imaging unit to a housing according to an embodiment of the present disclosure.

FIG. 7 is a diagram illustrating a method of attaching a thermal conductive member according to an embodiment of the present disclosure.

FIGS. 8A to 8C are diagrams illustrating deformation of the image sensor holder and a position of the image sensor caused by changes in ambient temperature and the effect of solar radiation, according to an embodiment of the present disclosure.

FIG. 9 is a diagram illustrating a configuration of a transportation apparatus according to an embodiment of the present disclosure.

### DESCRIPTION OF THE EMBODIMENTS

Various exemplary embodiments, features, and aspects of the present disclosure will be described with reference to the accompanying drawings. The embodiments described below are merely examples, and the present disclosure is not limited to the illustrated configurations and the like.

In this specification, the temperature of the environment in which an object is located is referred to as “ambient temperature.” The ambient temperature refers to, for example, the temperature of the air, a room, the interior of a vehicle, or the inside of an enclosure.

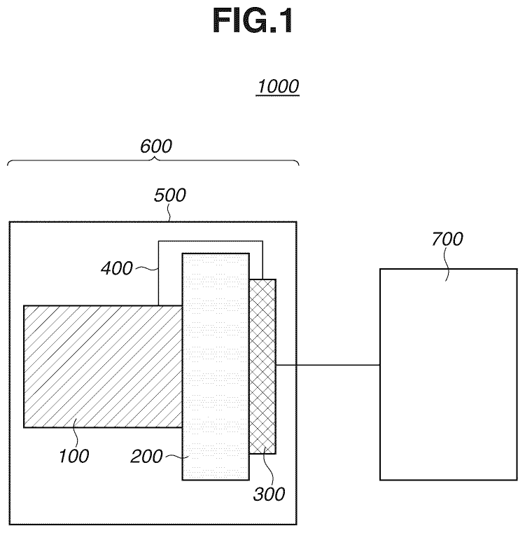

FIG. 1 illustrates a schematic diagram of a camera module 600, which is an example of an imaging device according to the present disclosure. The camera module 600 is connected to an information processing unit 700 to form an in-vehicle camera 1000. The camera module 600 includes a lens barrel unit 100, a housing 200, an imaging unit 300, a thermal conductive member 400, and an enclosure 500. The enclosure 500 houses the lens barrel unit 100, the housing 200, the imaging unit 300, and the thermal conductive member 400, and provides functions such as shock resistance and dust protection. The lens barrel unit 100 is held by the housing 200, and the imaging unit 300 is adhesively fixed to the housing 200 in a state where optical adjustment has been performed, which will be described below. A part of the thermal conductive member 400 is connected to the imaging unit 300, and another part of the thermal conductive member 400 is connected to the lens barrel unit 100.

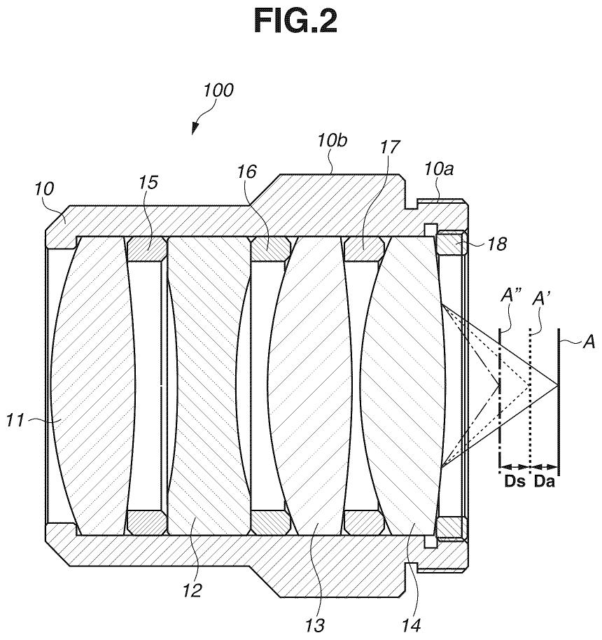

FIG. 2 is a cross-sectional view illustrating a cross-section including an optical axis at a central portion of the lens barrel unit 100. The lens barrel unit 100 includes a lens barrel 10. The lens barrel unit 100 further includes lenses 11 to 14 and a retaining ring 18, all of which are held in the lens barrel 10. The lenses 11 to 14 are arranged to be spaced apart from each other using ring-shaped spacers 15, 16, and 17, each of which serves as one of lens holding members. The lens barrel 10 is made of a metallic material or a plastic material, and the lenses 11, 12, 13, and 14 are made of a material having light transmittance, such as a glass material or a resin material, to allow light to pass through.

An external thread portion (not illustrated) disposed in an outer diameter portion of the retaining ring 18, which is one of the lens holding members, is screwed into an internal thread portion (not illustrated) disposed in an inner diameter portion of the lens barrel 10, thus fixing the lenses 11, 12, 13, and 14 and the spacers 15, 16, and 17. In addition, the lens barrel 10 includes an external thread portion 10a for fixing the lens barrel unit 100 to the housing 200 in the outer diameter portion. The lens barrel 10 further includes an outer diameter portion 10b for connection with the thermal conductive member 400.

A surface A illustrated in FIG. 2 indicates the focal position at an ambient temperature T₀, where the influence of solar radiation is negligibly small, a surface A′ indicates the focal position at an ambient temperature T₁ (where T₀<T₁). When the ambient temperature changes, the back focus of the optical system varies due to changes in the thicknesses of the spacers 15, 16, and 17, as well as changes in the shape and refractive index (temperature characteristics) of the respective lenses 11, 12, 13, and 14.

In general, as the ambient temperature increases, the back focus shifts in the direction in which the back focus becomes shorter, as illustrated in FIG. 2. This back focus shift is denoted by Dₐ.

Further, when the temperature of the entire or a part of the constituent members of the lens barrel unit 100 rises due to solar radiation, the back focus shifts in the direction in which the back focus becomes shorter due to changes in the thickness of the spacers, changes in the shape of the lenses, and changes in their refractive index (temperature characteristics). This amount of back focus shift caused by solar radiation is denoted by Dₛ. The back focus shift Dₛ varies with the solar radiation conditions. The back focus shift Dₛ increases as the solar radiation intensity increases, and it may also occur even when the ambient temperature does not necessarily rise. Thus, it is important to maintain excellent imaging performance of the camera module 600 even under widely varying ambient temperatures and solar radiation conditions. To achieve this, the imaging unit 300 may be held to accommodate the back focus shift caused by the above-described changes in ambient temperature and solar radiation.

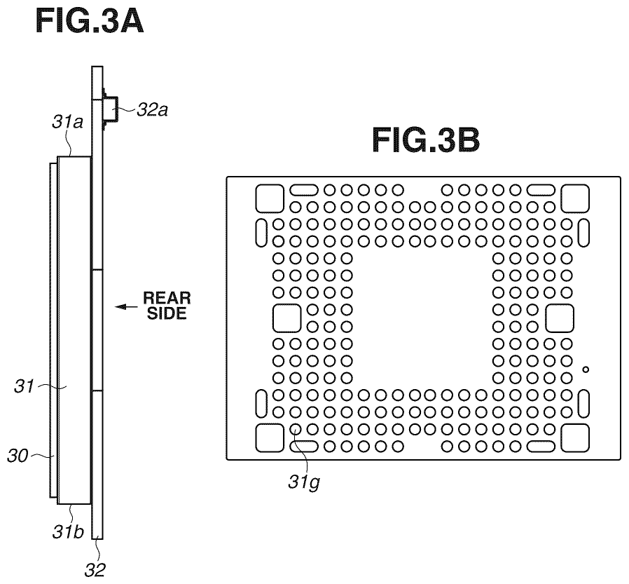

Next, an image sensor 31 and an image sensor substrate 32 will be described with reference to FIGS. 3A and 3B. FIG. 3A is a side view of the image sensor 31 mounted on the image sensor substrate 32, and FIG. 3B is a rear view of the image sensor 31.

The image sensor 31 includes therein a photoelectric conversion unit, and is mounted on the image sensor substrate 32 as illustrated in FIG. 3A. An object image formed on the image plane by light transmitted through the lenses in the lens barrel unit 100 and received by the image sensor 31 is photoelectrically converted into electrical signals by the photoelectric conversion unit. In the present embodiment, a Complementary Metal-Oxide-Semiconductor (CMOS) sensor is used as the image sensor 31, but the image sensor 31 is not limited to this. Other imaging devices, such as a Charge-Coupled Device (CCD) sensor and a Charge Injection Device (CID) sensor, may be used. The front side (the side on which light is incident) of the image sensor 31 is covered by a cover glass 30. Electrode pads 31g are disposed on the rear side (the side opposite to the light incident side) of the image sensor 31, and the electrode pads 31g are electrically connected to the photoelectric conversion unit of the image sensor 31.

The image sensor substrate 32 is electrically connected to the photoelectric conversion unit of the image sensor 31 via the electrode pads 31g, and receives electric signals from the image sensor 31. A substrate connector 32a that is electrically connected to a control circuit (not illustrated) of the information processing unit 700 is disposed on the rear side of the image sensor substrate 32.

The electrode pads 31g of the image sensor 31 are soldered to land portions (not illustrated) of the image sensor substrate 32 through an automated mounting process, and are thereby electrically connected to the image sensor substrate 32. Thus, the image sensor 31 is integrated with the image sensor substrate 32. The image sensor substrate 32 may be a substrate having flexibility, such as a flexible printed circuit board (FPC). The cover glass 30 is adhesively fixed to the image sensor 31 in a state of being overlaid on the front side of the image sensor 31, preventing foreign matter from adhering to the image plane of the image sensor 31.

The electric signals output from the photoelectric conversion unit of the image sensor 31 are transmitted to the image sensor substrate 32 via the electrode pads 31g, and further transmitted, from the image sensor substrate 32, to a control circuit (not illustrated) of the information processing unit 700 via the substrate connector 32a. The desired image processing is then performed.

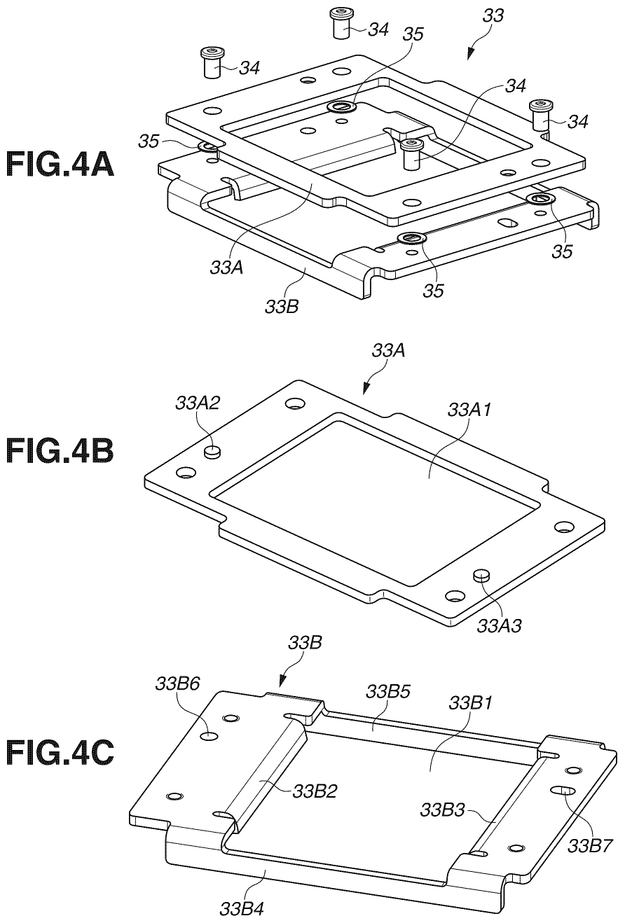

Next, an image sensor holder 33 to which the image sensor 31 is positioned and fixed will be described with reference to FIGS. 4A to 4C. FIG. 4A is an exploded perspective view of the image sensor holder 33, FIG. 4B is a perspective view of a first sensor holder component 33A, and FIG. 4C is a perspective view of a second sensor holder component 33B.

As illustrated in FIG. 4A, the image sensor holder 33 includes the first sensor holder component 33A containing a first material, the second sensor holder component 33B containing a second material, and low thermal conductivity members 35. These members are arranged in the order of the first sensor holder component 33A, the low thermal conductivity members 35, and the second sensor holder component 33B when viewed from the front side of the camera module 600, in other words, in the order of proximity to the lenses in the optical path direction along the optical axis of the lenses.

As the first material contained in the first sensor holder component 33A, at least one selected from a group comprising stainless steel, an aluminum alloy, copper alloy, polycarbonate resin (PC resin), polyphenylene sulfide resin (PPS resin), or the like, may be used. From the viewpoint of improving strength, polycarbonate resin and polyphenylene sulfide resin containing glass fibers may also be used. Furthermore, from the viewpoint of allowing sufficient deformation, the first material can be the main component of the first sensor holder component 33A. Here, the term “main component” refers to a material that constitutes 50 wt % (weight percentage) or more of the component.

As the second material, at least one selected from a group comprising carbon steel, stainless steel, a copper alloy, an aluminum alloy, or the like, may be used. From the viewpoint of allowing sufficient deformation, the second material can be the main component of the second sensor holder component 33B. Here, the term “main component” refers to a material that constitutes 50 wt % or more of the component.

The first sensor holder component 33A has an opening 33A1 to expose the image plane of the image sensor 31, and includes protrusions 33A2 and 33A3 for positioning with respect to the second sensor holder component 33B. The surface of first sensor holder component 33A can be treated with an anti-reflection treatment, such as plating or coating. In other words, the surface of the first sensor holder component 33A can be coated with a material different from the first material, which is the main component forming the first sensor holder component 33A. Here, the term “main component” refers to a material that constitutes 50 wt % or more of the component.

The second sensor holder component 33B has an opening 33B1 to expose the image plane of the image sensor 31. The opening 33B1 is formed with projections 33B2 and 33B3 that project toward the rear side of the second sensor holder component 33B, and a part of an outer edge of the second sensor holder component 33B is formed with projections 33B4 and 33B5 that project toward the rear side. In addition, a pair of a positioning hole 33B6 and an anti-rotation hole 33B7 is formed in the second sensor holder component 33B. In the present embodiment, both the projections 33B4 and 33B5 project toward the rear side, but the present disclosure is not limited thereto. Both the projections 33B4 and the 33B5 may project toward the front side, or may project in different directions.

The first sensor holder component 33A is configured with the low thermal conductivity members 35 disposed between the first sensor holder component 33A and the second sensor holder component 33B. The position is determined by fitting the protrusions 33A2 and 33A3 into the pair of the positioning hole 33B6 and the anti-rotation hole 33B7 disposed in the second sensor holder component 33B. The positioned first sensor holder component 33A is integrally joined with the second sensor holder component 33B and the low thermal conductivity members 35 by fastening the first sensor holder component 33A with screws 34 at four locations.

In the present embodiment, the first sensor holder component 33A is joined by fastening with screws at four locations, but the present disclosure is not limited thereto. It is sufficient if the components are joined at least two locations to be integrated. In other words, the first sensor and second holder components 33A and 33B can be effectively integrated by being joined at two or more locations.

Furthermore, the method for joining the components is not limited to screw fastening. The components can be joined by at least one method selected from a group comprising screw fastening, swaging, welding, thermal welding, adhesion, or the like. In addition, in the present embodiment, the projections 33B2 and 33B3, which serve as connection portions to the image sensor 31, and the projections 33B4 and 33B5, which serve as connection portions to the housing 200, are disposed on the second sensor holder component 33B; however, the plurality of connection portions may instead be disposed on the first sensor holder component 33A.

As will be described below, the image sensor 31 is maintained within a range that ensures the performance of the in-vehicle camera 1000 under a wide range of ambient temperatures and various sunlight conditions, by moving in the optical axis direction due to deformation of the image sensor holder 33 caused by changes in ambient temperature and/or the effects of sunlight. Normally, when the temperature of the lens barrel unit 100 increases due to ambient temperature and/or sunlight, the back focus tends to shift in a direction that shortens the back focus. Therefore, the image sensor 31 may be configured to be moved in a direction approaching the lens barrel unit 100.

Specifically, in order to achieve both the movement of the image sensor 31 in the above-described direction and the miniaturization of the device, the linear expansion coefficient αₐ of the first material may be selected to be greater than the linear expansion coefficient α_{b} of the second material. Furthermore, to increase the amount of movement of the image sensor 31, the difference between the linear expansion coefficients αₐ of the first material and the linear expansion coefficient α_{b} of the second material can be at least 3.5×10⁻⁶/° C.

Here, the linear expansion coefficient α is defined based on the rate of elongation per unit temperature change. When a solid sample with an initial length L₀ at temperature T₀° C. is heated to T₁° C. and the amount of elongation is ΔL, the linear expansion coefficient α(/° C.) is given by (ΔL/L₀)[1/(T₁−T₀)].

In order to reduce variations in the amount of deformation caused by differences in the shapes, physical properties, and the like of individual components, the linear expansion coefficient αₐ of the first material can fall in the range of 14.0×10⁻⁶/° C. to 24.0×10⁶/° C., inclusive. Similarly, from a similar perspective, the linear expansion coefficient α_{b} of the second material can fall in the range of 9.9×10⁻⁶/° C. and 20.5×10⁻⁶/° C., inclusive.

As will be described below, the low thermal conductivity members 35 serve to generate a difference in temperature increase between the first sensor holder component 33A and the second sensor holder component 33B under the effect of solar radiation. In order to effectively perform this function, it is desirable that the thermal conductivity of the low thermal conductivity members 35 be 0.5 W/m·° C. (watts/meter×degree Celsius) or less, and more desirably 0.4 W/m·° C. or less.

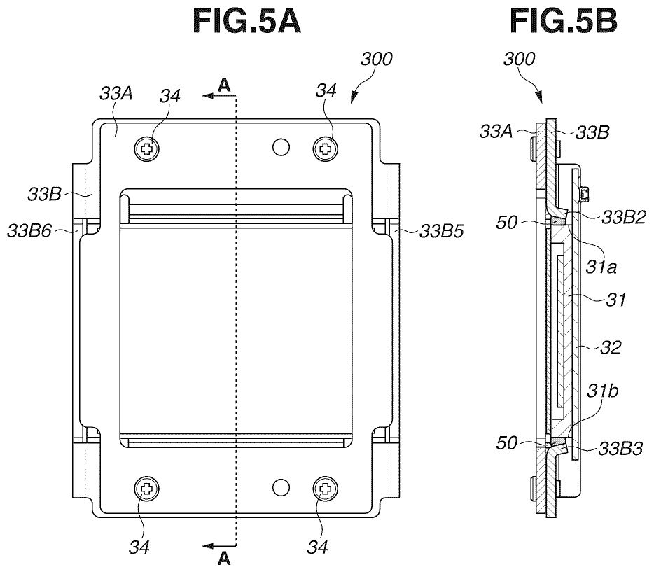

Next, a method of fixing the image sensor 31 to the image sensor holder 33 will be described with reference to FIGS. 5A and 5B. FIG. 5A is a front view of the image sensor holder 33 fixed to the image sensor 31, and FIG. 5B is a cross-sectional view, taken along line A-A in FIG. 5A.

The imaging unit 300 is configured in such a manner that the image sensor 31 is assembled to the image sensor holder 33 from the rear side so that the image sensor 31 fits into the opening 33B1 of the second sensor holder component 33B. When the image sensor 31 is assembled to the image sensor holder 33, the image sensor holder 33 is fixed, and the center of the image plane in the image sensor 31 is adjusted to be aligned approximately with the center of the opening 33B1 of the second sensor holder component 33B using a position adjustment jig.

After the position adjustment is completed, an adhesive 50 is filled into the spaces between side surfaces 31a and 31b of the image sensor 31 and the projections 33B2 and 33B3 which are inclined by a predetermined amount toward the rear side in the optical axis direction, and then cured.

The image sensor 31 is fixed to the image sensor holder 33 by the adhesive 50. Since the image sensor 31 is assembled from the rear side of the image sensor holder 33 and the side surfaces 31a and 31b of the image sensor 31 are adhesively held, the second sensor holder component 33B has a shape that does not overlap the image sensor 31 in the optical axis direction.

As will be described below, the deformation amount of the image sensor holder 33 varies depending on the thicknesses of the first sensor holder component 33A and the second sensor holder component 33B. In other words, adjustment of the thicknesses of the first sensor holder component 33A and the second sensor holder component 33B enables the design of the image sensor holder 33 that can produce a desired deformation amount.

The projections 33B2 and 33B3 bonded to the image sensor 31 ensure a bonding area between the second sensor holder component 33B and the image sensor 31, irrespective of the thickness of the second sensor holder component 33B. This design ensures the impact resistance of the imaging unit 300. In addition, when the adhesive 50 cures, the projections 33B2 and 33B3 of the second sensor holder component 33B deform, which reduces the stress applied to the image sensor 31, thus preventing deformation of the image sensor 31.

The projections 33B2 and the 33B3 can be shaped to be inclined by a predetermined amount toward the rear side with respect to the optical axis. Thus, the spaces between the side surfaces 31a and 31b and the projections 33B2 and 33B3 of the image sensor 31 are formed so that the spaces gradually narrow toward the rear side. This shape prevents the adhesive 50 from flowing out toward the image sensor substrate 32. The adhesive 50 can be one that is highly heat-resistant, and more specifically, one with a glass transition temperature (Tg) of 85° C. or higher is desirable.

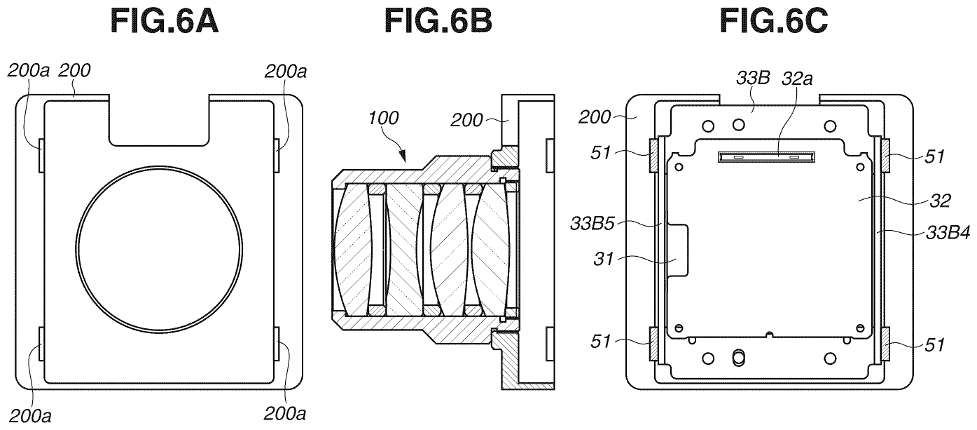

Next, a method of attaching the lens barrel unit 100 to the housing 200 and a method of fixing the imaging unit 300 to the housing 200 will be described with reference to FIGS. 6A to 6C. FIG. 6A is a rear view of the housing 200, FIG. 6B is a cross-sectional view with the lens barrel unit 100 fixed to the housing 200, and FIG. 6C illustrates a state in which the imaging unit 300 is incorporated into the housing 200 and then bonded and fixed with adhesive 51.

On the rear side of the housing 200, four adhesive grooves 200a are disposed into which an adhesive 51 is to be filled to fix the imaging unit 300. The lens barrel unit 100 is fixed to the housing 200 by screwing the external thread portion 10a, formed on the lens barrel 10, into an internal thread portion (not illustrated) disposed on the housing 200.

The imaging unit 300 is adjusted so that the image plane of the image sensor 31 is positioned within an acceptable tolerance range in which desired imaging performance of the in-vehicle camera 1000 can be secured, with the focal position of the lens barrel unit 100 incorporated in the housing 200 as the center. After the adjustment is completed, the spaces between the projections 33B5 and 33B6, disposed on the second sensor holder component 33B, and the adhesive grooves 200a, formed in the housing 200, are filled with the adhesive 51 and cured thus fixing the imaging unit 300 to the housing 200. The adhesive 51 can be one that is highly heat-resistant, and more specifically, one with a glass transition temperature (Tg) of 85° C. or higher is desirable.

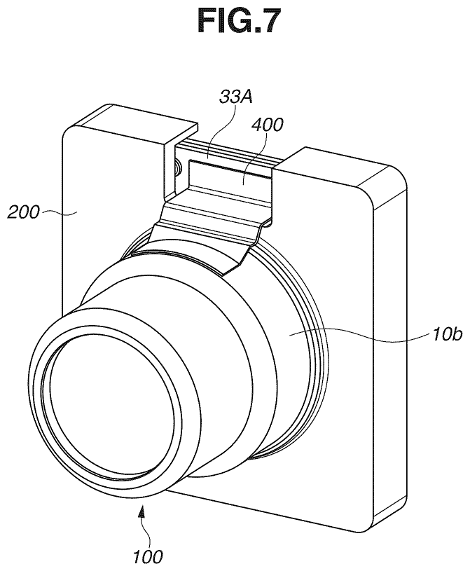

Referring now to FIG. 7, a method of assembling the thermal conductive member 400 will now be described. FIG. 7 is a perspective view of the camera module 600 (the enclosure 500 is not illustrated).

The thermal conductive member 400 has an adhesive layer on at least one side thereof in the thickness direction. A part of the thermal conductive member 400 is attached to the first sensor holder component 33A via the adhesive layer, and another part of the thermal conductive member 400 is attached to the outer diameter portion 10b of the lens barrel 10 via the adhesive layer. The thermal conductive member 400 serves to transfer solar radiation energy incident on the lens barrel unit 100 to the imaging unit 300. In order to realize efficient transfer of solar radiation energy, the thermal conductivity (second thermal conductivity) of the thermal conductive member 400 is desirably equal to or higher than the thermal conductivity (first thermal conductivity) of the lens barrel 10.

The thermal conductive member 400 can be flexible so as not to hinder deformation (curving) of the image sensor holder 33. In the present embodiment, the thermal conductive member 400 includes an adhesive layer and is attached to the first sensor holder component 33A and the outer diameter portion 10b of the lens barrel 10 via the adhesive layer, but the present disclosure is not limited thereto. The attachment method may be by adhesive fixation or by pressing with mechanical components or the like. The above-described adhesive can be one with high thermal conductivity, specifically, one with a thermal conductivity of 1.5 W/m·° C. or higher is suitable.

The materials used for the lens barrel 10 and the thermal conductive member 400 are not particularly limited as long as they satisfy the above-described relationship, and various materials can be suitably used. As the main material for the lens barrel 10, a metal material such as an aluminum alloy can be used. The thermal conductivity of aluminum alloys is generally around 130 to 230 W/m·° C. As the main material for the thermal conductive member 400, copper or graphite sheets can be used. The thermal conductivity of copper is generally around 360 to 370 W/m·° C. The thermal conductivity of graphite sheets is high in the in-plane direction, approximately 700 to 1000 W/m·° C., but in the thickness direction, it is about 1/200 of that value, indicating anisotropy in thermal conductivity. Therefore, in a case where using a graphite sheet as the thermal conductive member 400, it is desirable to arrange the graphite sheet so that heat is transferred in the in-plane direction of the graphite sheet to thermally connect the lens barrel 10 and the first sensor holder component 33A. With such a configuration, since the second thermal conductivity is greater than the first thermal conductivity, excellent performance can be maintained even when back focus shift occurs due to ambient temperature changes and/or solar radiation effect.

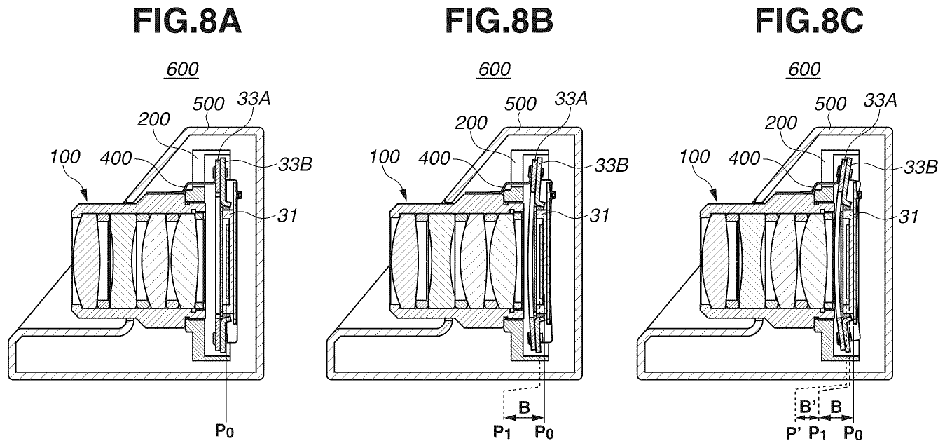

Next, with reference to FIGS. 8A to 8C, a description will be provided of a deformation state of the image sensor holder 33 and the movement of the image sensor 31 in the optical axis direction due to ambient temperature changes and/or solar radiation effect, which are features of the present disclosure. FIG. 8A illustrates a cross-sectional view of the camera module 600 at the ambient temperature T₀ where the effect of solar radiation is negligibly small. FIG. 8B illustrates a cross-sectional view of the camera module 600 at the ambient temperature T₁ (T₀<T₁). In FIG. 8A, P₀ indicates the position of the image plane of the image sensor 31 along the optical axis at the temperature T₀, while in FIG. 8B, P₁ indicates the position of the image plane of the image sensor 31 along the optical axis at the temperature T₁. FIG. 8C illustrates a cross-sectional view of the camera module 600 at the temperature T₁ under the effect of solar radiation, with P′ indicating the position of the image plane of the image sensor 31 along the optical axis. Hereafter, the state at the ambient temperature T₀, at which the effect of solar radiation is negligibly small, is referred to as the “reference state.

Initially, the behavior under ambient temperature changes in a state where the effect of solar radiation can be negligible will be described with reference to FIGS. 8A and 8B. When the ambient temperature rises from the reference state to T₁, both the first and second sensor holder components 33A and 33B expand. However, due to their different linear expansion coefficients, the expansion amounts differ between the first and second sensor holder components 33A and 33B. Since the first and second sensor holder components 33A and 33B are integrally configured, the difference in the expansion amount causes the image sensor holder 33 to deform (curve). Since the relationship between the linear expansion coefficient αₐ of the first material and the linear expansion coefficient α_{b} of the second material is αₐ>α_{b} as described above, the image sensor holder 33 deforms convexly toward the lens barrel unit 100. The image sensor 31 is fixed to the image sensor holder 33 with an adhesive, so that the image sensor 31 moves in the optical axis direction along with the deformation of the image sensor holder 33, shifting closer to the lens barrel unit 100. When the amount of the movement of the image plane of the image sensor 31 in the optical axis direction due to ambient temperature change is denoted by B, the image plane of the image sensor 31 moves by B in the optical axis direction on the lens barrel unit 100 side when the ambient temperature rises in a state where solar radiation is negligible.

As a result, the position of the image plane of the image sensor 31 changes from P₀ to P₁.

Next, the behavior under the effect of solar radiation will be described with reference to FIG. 8C. Under the effect of solar radiation at the ambient temperature T₁, the lens barrel unit 100 absorbs radiant energy from the sun and thus the temperature rises as compared with a case where there is no solar radiation effect. Since the imaging unit 300 is connected to the lens barrel unit 100 via the thermal conductive member 400, the radiant energy absorbed by the lens barrel unit 100 is partially transmitted, and the temperature rises as compared with the case where there is no solar radiation effect.

As the temperature of the imaging unit 300 increases, the difference in the amount of expansion between the first and second sensor holder components 33A and 33B increase as compared with a case where there is no solar radiation effect. In other words, the amount of deformation of the image sensor holder 33 also increases, and the amount of movement of the image sensor 31 in the optical axis direction increases as compared with the case where there is no solar radiation effect. The amount of the movement of the image plane of the image sensor 31 in the optical axis direction due to the effect of solar radiation is denoted by B′. When the ambient temperature rises from the reference state to the T₁ under the effect of solar radiation, the image plane of the image sensor 31 moves by B+B′in the optical axis direction of the lens barrel unit 100 side, and the position of the image plane of the image sensor 31 changes from the P₀ to P′.

As described above, the image sensor 31 moves in the optical axis direction due to the deformation of the image sensor holder 33, and the amount of the movement of the image sensor 31 in the optical axis direction is proportional to the amount of deformation of the image sensor holder 33. The amount of deformation of the image sensor holder 33 can be adjusted according to the linear expansion coefficients, the thicknesses, the fastening positions, the modulus of elasticity, and the like of the first and second sensor holder components 33A and 33B. Thus, the above-described movement amounts B and B′ of the image plane of the image sensor 31 in the optical axis direction can be freely set. In other words, appropriate design of the movement amounts B and B′ of the image plane of the image sensor 31 in the optical axis direction in consideration of the back focus shifts (Dₐ and Dₛ) of the optical system caused by changes in ambient temperature and the effect of solar radiation enables the image plane of the image sensor 31 to be held within the above-described allowable tolerance range. As a result, the in-vehicle camera 1000 can maintain excellent performance across a wide range of ambient temperatures and various solar radiation conditions.

In the present embodiment, the low thermal conductivity members 35 are disposed between the first and second sensor holder components 33A and 33B. Due to the presence of the low thermal conductivity members 35, when solar radiation is present, a difference arises in the amount of temperature increase between the first and second sensor holder components 33A and 33B, and the first sensor holder component 33A consistently exhibits a high temperature increase. Since the relationship between the linear expansion coefficient αₐ of the first material and the linear expansion coefficient α_{b} of the second material is αₐ>α_{b} as described above, the difference in the amount of expansion between the first and second sensor holder components 33A and 33B is larger than that in the case where the low thermal conductivity members 35 are not provided. As a result, as compared with the case where the low thermal conductivity members 35 are not provided, the amount of movement of the image sensor 31 in the optical axis direction can be increased, enabling the miniaturization of the image sensor holder 33, and consequently, the miniaturization of the camera module 600. In addition, connecting the lens barrel unit 100 to the imaging unit 300 with the thermal conductive member 400 enables reduction of the temperature rise of the lens barrel unit 100 due to solar radiation, thus reducing the back focus shift (Dₛ) due to solar radiation. As a result, the required amount of deformation of the image sensor holder 33 can be reduced, thus enabling the miniaturization of the image sensor holder 33 and, consequently, the miniaturization of the camera module 600.

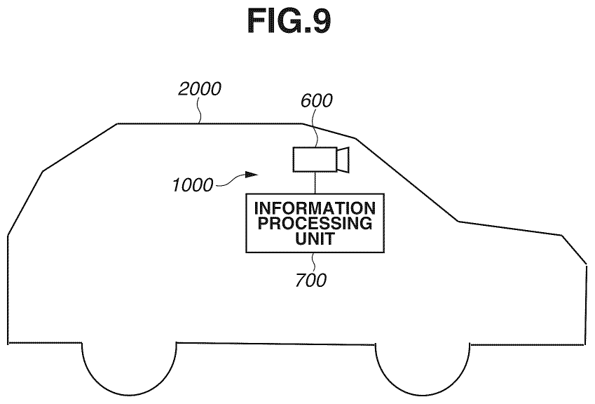

The embodiment of the present disclosure is not limited to the above, and may also be applied to a transportation apparatus equipped with a vehicle body or movable body that includes a camera module 600 and the information processing unit 700. A schematic configuration diagram of the present disclosure is illustrated in FIG. 9. The transportation device may be, for example, a vehicle, a ship, or an aircraft. A transportation apparatus 2000 according to the present disclosure includes the imaging unit 300 that deforms toward the lens side as the ambient temperature rises, and the imaging unit 300 is connected to the lens barrel unit 100 via the thermal conductive member 400. This configuration enables high-precision image capturing even under a wide range of ambient temperatures and various solar radiation conditions.

The disclosure of the present embodiment includes the following configurations.

### (Configuration 1)

An imaging device including:
a lens;
a lens holding member for holding the lens, the lens holding member having a first thermal conductivity;
an imaging unit including an image sensor and an image sensor holder; and
an enclosure accommodating the lens holding member and the imaging unit,
wherein the imaging unit is configured such that a position of the image sensor shifts toward the lens as a temperature of the image sensor holder increases,
wherein the imaging device further comprises a thermal conductive member that has a second thermal conductivity and is accommodated within the enclosure, the thermal conductive member being different from the enclosure a part of which is connected to the image sensor holder and another part of which is connected to the lens holding member, and
wherein the second thermal conductivity is equal to or greater than the first thermal conductivity.

### (Configuration 2)

The imaging device according to configuration 1, wherein the thermal conductive member includes an adhesive layer, and is connected to the lens holding member and the image sensor holder via the adhesive layer.

### (Configuration 3)

The imaging device according to configuration 1, wherein the thermal conductive member is bonded to the lens holding member and the image sensor holder with an adhesive.

### (Configuration 4)

The imaging device according to any one of configurations 1 to 3, wherein the image sensor holder includes a first member including a first material and a second member including a second material different from the first material in order of proximity to the lens in an optical path direction along an optical axis of the lens, and the first material is larger in linear expansion coefficient than the second material.

### (Configuration 5)

The imaging device according to configuration 4, wherein the first member and the second member are joined at two or more positions.

### (Configuration 6)

The imaging device according to configuration 4 or 5, wherein the first member and the second member are joined by at least one of screw fastening, swaging, welding, thermal welding, or adhesion.

### (Configuration 7)

The imaging device according to any one of configurations 4 to 6, wherein the thermal conductive member is coupled to the first member.

### (Configuration 8)

The imaging device according to configuration 4, wherein a third member is disposed between the first member and the second member, and a thermal conductivity of the third member is equal to or less than 0.5 W/m·° C.

### (Configuration 9)

The imaging device according to any one of configurations 1 to 8, further comprising a housing that holds the lens holding member and the image sensor holder.

### (Configuration 10)

The imaging device according to configuration 9, wherein the housing holds the image sensor holder via a resin material having a glass transition temperature (Tg) of 85° C. or higher.

### (Configuration 11)

The imaging device according to any one of configurations 4 to 8, wherein the first member is coated with a material different from the first material.

### (Configuration 12)

The imaging device according to any one of configurations 1 to 11, wherein the thermal conductive member includes copper or a graphite sheet.

### (Configuration 13)

The imaging device according to any one of configurations 1 to 12, wherein the lens holding member includes an aluminum alloy.

### (Configuration 14)

An in-vehicle camera comprising:
the imaging device according to any one of configurations 1 to 13; and
an information processing unit configured to process an electric signal photoelectrically converted by the image sensor.

### (Configuration 15)

A transportation apparatus comprising:
the imaging device according to any one of configurations 1 to 13;
an information processing unit configured to process an electric signal photoelectrically converted by the image sensor; and
a vehicle body or a movable body.

According to the present disclosure, an imaging device capable of maintaining excellent imaging performance even when back focus shift occurs due to changes in ambient temperature and the effects of solar radiation, an in-vehicle camera including the imaging device, and a transportation apparatus including the imaging device can be provided

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-125744, filed Aug. 1, 2024, which is hereby incorporated by reference herein in its entirety.

What is claimed is:

1. An imaging device comprising:
a lens;
a lens holding member for holding the lens, the lens holding member having a first thermal conductivity;
an imaging unit including an image sensor and an image sensor holder; and
an enclosure accommodating the lens holding member and the imaging unit,
wherein the imaging unit is configured such that a position of the image sensor shifts toward the lens as a temperature of the image sensor holder increases,
wherein the imaging device further comprises a thermal conductive member that has a second thermal conductivity and is accommodated within the enclosure, the thermal conductive member being different from the enclosure a part of which is connected to the image sensor holder and another part of which is connected to the lens holding member, and
wherein the second thermal conductivity is equal to or greater than the first thermal conductivity.

2. The imaging device according to claim 1, wherein the thermal conductive member includes an adhesive layer, and is connected to the lens holding member and the image sensor holder via the adhesive layer.

3. The imaging device according to claim 1, wherein the thermal conductive member is bonded to the lens holding member and the image sensor holder with an adhesive.

4. The imaging device according to claim 1, wherein the image sensor holder includes a first member including a first material and a second member including a second material different from the first material in order of proximity to the lens in an optical path direction along an optical axis of the lens, and the first material is larger in linear expansion coefficient than the second material.

5. The imaging device according to claim 4, wherein the first member and the second member are joined at two or more positions.

6. The imaging device according to claim 4, wherein the first member and the second member are joined by at least one of screw fastening, swaging, welding, thermal welding, or adhesion.

7. The imaging device according to claim 4, wherein the thermal conductive member is coupled to the first member.

8. The imaging device according to claim 4, wherein a third member is disposed between the first member and the second member, and a thermal conductivity of the third member is equal to or less than 0.5 W/m·° C.

9. The imaging device according to claim 1, further comprising a housing that holds the lens holding member and the image sensor holder.

10. The imaging device according to claim 9, wherein the housing holds the image sensor holder via a resin material having a glass transition temperature (Tg) of 85° C. or higher.

11. The imaging device according to claim 4, wherein the first member is coated with a material different from the first material.

12. The imaging device according to claim 1, wherein the thermal conductive member includes copper or a graphite sheet.

13. The imaging device according to claim 1, wherein the lens holding member includes an aluminum alloy.

14. An in-vehicle camera comprising:
the imaging device according to claim 1; and
an information processing unit configured to process an electric signal photoelectrically converted by the image sensor.

15. A transportation apparatus comprising:
the imaging device according to claim 1;
an information processing unit configured to process an electric signal photoelectrically converted by the image sensor; and
a vehicle body or a movable body.
